(19) United States
(12) Patent Application Publication
(10) Pub. No.: US 2014/0294512 A1
(43) Pub. Date: Oct. 2, 2014

(54) Powered Slip Actuation

(71) Applicant: Earth Tool Company LLC, Oconomowoc, WI (US)

(72) Inventors: Steven W. Wentworth, Fountain Hills, AZ (US); Robert F. Crane, Oconomowoc, WI (US); Mark D. Randa, Summit, WI (US)

(73) Assignee: Earth Tool Company LLC, Oconomowoc, WI (US)

(21) Appl. No.: 14/242,546

(22) Filed: Apr. 1, 2014

Related U.S. Application Data
(60) Provisional application No. 61/807,004, filed on Apr. 1, 2013.

(51) Int. Cl. F16L 1/036; E21B 19/08

(52) U.S. Cl. CPC F16L 1/036; E21B 19/08
USPC 405/184; 175/85; 294/207

(57) ABSTRACT

A system for pushing and pulling rod strings through the ground or an underground pipe. The apparatus has a downhole tool attached to the distal end of the rod string. The push/pull machine has a stationary frame that is placed against the ground to provide a reaction surface. The stationary frame has an opening for the rod string to pass through. A rod gripping assembly is supported on the machine frame and moveable relative to the stationary frame. The rod gripping assembly has a slip bowl, jaws, a thrust member and an actuator. The actuator powers movement of the jaws into the slop bowl to cause a powered gripping of the rod string by the machine. With the rod string gripped a cylinder assembly is activated to push the rod gripping assembly toward the stationary frame thereby pushing the rod string into the ground.

### CROSS REFERENCE TO RELATED APPLICATION

This application claims the benefit of provisional patent application Ser. No. 61/807,004, filed on Apr. 1, 2013, the entire contents of which are incorporated herein by reference.

### FIELD

The present invention relates generally to machines for pushing and pulling rod strings through the ground and specifically to machines used to replace underground pipe and utilities.

### SUMMARY

The present invention is directed to an apparatus for pushing and pulling a rod string. The apparatus comprises a downhole tool, a stationary frame, a rod gripping assembly, and a cylinder assembly. The rod string is connected to the downhole tool at a first end and comprises a plurality of rod string sections connected together end-to-end. The stationary frame has an opening for the rod string to pass through the stationary frame. The rod gripping assembly comprises a slip bowl assembly, a pair of jaws disposed within the slip bowl assembly and around a rod string section disposed within the slip bowl assembly, a thrust member aligned with the slip bowl, and an actuator. The jaws are connected to the thrust member. The actuator moves the thrust member and the jaws relative to the slip bowl assembly to push the jaws into the slip bowl assembly to grip the rod string section disposed within the slip bowl assembly. The cylinder assembly pushes and pulls the rod gripping assembly relative to the stationary frame when the jaws are gripping the rod string and moves the gripping assembly relative to the rod string when the actuator has moved the yoke away from the slip bowl assembly to release the grip of the pair of jaws.

The present invention is directed to a rod gripping assembly. The assembly comprises a slip bowl assembly, a pair of jaws, a thrust member, and an actuator. The slip bowl assembly comprises a front flange, a rear flange, and a bowl supported between the front flange and the rear flange. The bowl has an opening with a greater diameter at an end proximate the rear flange and a lesser diameter at an end proximate the front flange. The jaws are disposed within the opening of the bowl and to surround a rod string section disposed within the opening. The thrust member is aligned with the opening of the bowl. The jaws are connected to the thrust member. The actuator moves the thrust member and jaws relative to the bowl to push the jaws into the bowl toward the end proximate the front flange to cause the jaws to grip the rod string section.

The present invention is likewise directed to a method for the replacement of an underground pipe. The method comprises connecting a rod string section to an end of a rod string and gripping the rod string section by moving a pair of jaws within a slip bowl assembly.

The rod string section is thrust toward the underground pipe while gripping the rod string section with the pair of jaws. The rod string section is released by partially withdrawing the pair of jaws from the slip bowl assembly and the pair of jaws are moved toward a proximate end of the rod string section. The rod string section or a new rod string section connected to the end of the rod string is gripped and thrust further into the underground pipe.

### BRIEF DESCRIPTION OF THE DRAWINGS

FIG. 1 is a diagrammatic representation of one possible use of the rod gripping mechanism of the present invention in a utility installation operation.

FIG. 2 is an isometric view of a rod pushing/pulling machine with the external housing and hydraulics removed.

FIG. 3 is an isometric view of the rod pushing/pulling machine of FIG. 2 shown from the opposite end with several hydraulic pathways shown.

FIG. 4 is a diagrammatic illustration of a rod gripping assembly of the machine of FIGS. 2 and 3.

FIG. 5 is a top view of the rod gripping assembly of FIG. 4.

FIG. 6 is a longitudinal section view of the rod gripping assembly of FIG. 4 taken along line 6-6.

FIG. 7 is a sectional view of an alternative rod gripping assembly.

### DESCRIPTION

As the infrastructure of underground utilities has aged the need to replace these underground utilities has grown. However, home and business owners do not like to have their landscaping and streets dug up during the replacement of underground utilities. Thus, systems and methods for the replacement of underground utilities with minimal surface disruption have been developed. For example, horizontal directional drills are regularly used to install new and replace old utilities. Another technology widely used is pit launched rod pushing and pulling machines. These machines push a rod string, comprised of a series of rod string sections attached end-to-end, through the existing pipeline from the launch pit to an exit point remote from the machine. Sections of rod are added to the rod string as the rod string is pushed into the pipe.

One skilled in the art will appreciate that a downhole tool comprising a drill bit could be attached to the far end of the rod string to allow the rod string to be pushed through the ground or an existing pipe. Once the far end of the rod string reaches the target point a downhole tool may be attached to the far end of the rod string. The new pipe to be installed may be connected to the downhole tool so that the new pipe follows the downhole tool back through the ground or old pipe to the launch pit. The machine grips the rod string and, using hydraulic cylinders, pulls the rod string, downhole tool, and new pipe toward the launch pit. The downhole tool may comprise a pipe bursting head configured to either burst or slice the old pipe and push it into the surrounding soil.

Threaded pipe or rod strings are generally used in vertical and horizontal drilling and particularly in pipe bursting. The pipe sections range in length from a section of two feet to over fifteen feet in oil and gas operations. High tensile loads are applied to rod strings, whether they are hung vertically in a miles deep bore or deployed horizontally in a pipe burst.

Oil rigs use gravity assisted slips to hold the drill string off the bottom of the bore, such as when tripping out to change the drilling tooling, or to provide torsional restraint when adding or removing the top pipe from the string. Gravity assisted slips have a heavy walled outer slip bowl, slips, and jaws. The slip bowl is generally mounted on a structure that passes reaction forces to the ground, The slip bowl is ring shaped and has a conical inside surface running for its functional length, both ends of the bowl are open. The pipe or rod string is disposed at cylindrical centerline of the slip bowl. The angle of the conical side relative to the centerline is on the order of five (5) to fifteen (15) degrees with a preferred angle of ten (10) degrees per side. Without the slips engaged with the rod string, the rod string is free to move in either direction along the axial centerline, Slips are generally thin walled segments having a conical surface on a first side and a cylindrical surface on a second side. The conical surface of the slip is configured to slide with low friction against the conical inner surface of the slip bowl. The cylindrical inner surface of the slip is intended to produce a high coefficient of friction against the matching cylindrical surface of the rod and may have a hardened and serrated finish intended to bite into the mating rod surface. The inner surface is the jaw and may be a replaceable component within the slip. There are generally a minimum of two slips and often there are more, up to a dozen.

Gravity causes the slips to drop into the tapered annular space between slip bowl and the rod. This causes friction between the rod and the slips. As the rod string moves down under the force of gravity the slip moves with it deeper toward the small diameter end of the slip bowl. Movement continues until at least two opposing slips apply normal forces to the slip bowl cone and the rod string. At this point the rod will be centered in the bowl and both the normal forces and the friction forces of the engaged components rise quickly with slight distances of rod string travel.

The rod string and slips move deeper into the slip bowl until the friction forces on the rod string are equal in magnitude and opposite in direction to the weight (or other) forces pulling the rod string and causing movement. The rod will stop when the normal force around the bowl has caused the bowl to grow slightly within its elastic nature allowed by the geometry of all the components involved adjacent to and including the slip bowl. The present invention provides a system to induce slip movement toward the small end of the slip bowl without requiring the force of gravity. Such a system helps lead to successful clamping of the rod string in either the vertical or horizontal orientation. The system of the present invention also allows the rod string to be clamped when it is being pushed in a direction that would typically cause the slips and jaws to release their grip. Additionally, the system allows the rod string to be clamped for resisting torsional loads when no tensile or compressive load exists on the rod string to cause the jaws to grip the rod string. The powered gripping system of the present invention also provides a residual force on the rod string in the event the rod string is suddenly unloaded. The powered grip maintains the clamp load on the rod string and will cause the mass of the machine to absorb at least some of the stored energy to reduce the likelihood of the rod string traveling backwards through the machine unimpeded.

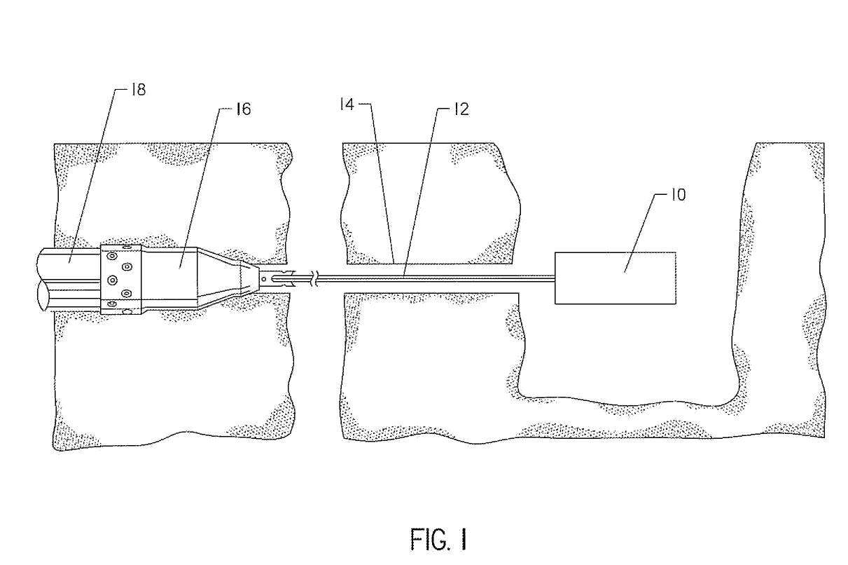

Turning now to the figures, FIG. 1 shows a rod pushing/pulling machine generally referred to herein as a thrust unit 10 intended for pipe bursting. The thrust unit 10 is connected to a rod string 12 for pushing into the ground or an existing pipe 14 and pulling back a downhole tool 16 and a new pipe 18. As show, the downhole tool 16 may comprise a pipe burster and swivel for connecting the downhole tool to the new pipe 18. The rod string 12 may be threaded, or may be hooked together by turning or fitting pipe sections together. One skilled in the art will appreciate that the process of pushing the rod 12 into the existing pipe 14 will require thrust force.

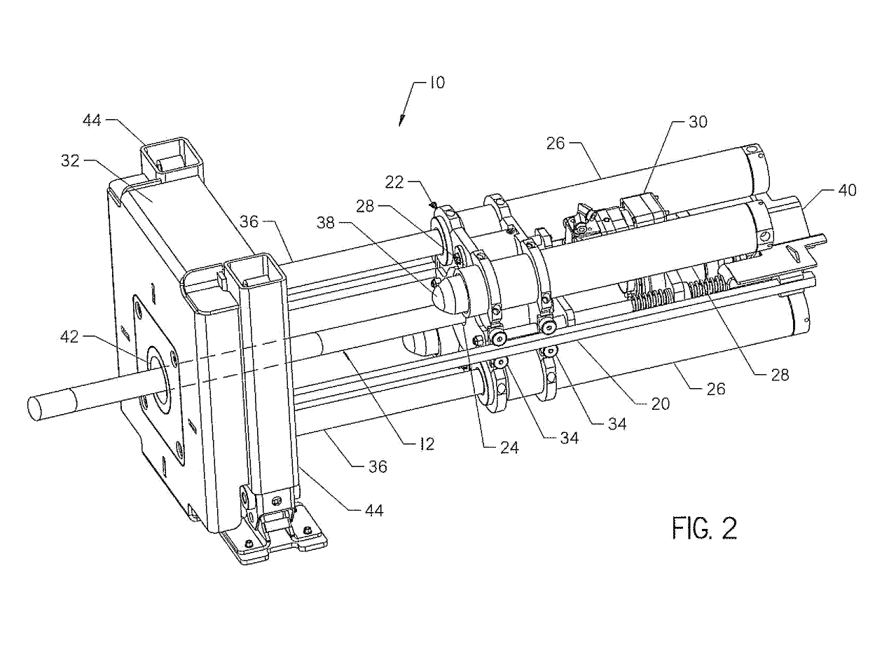

Turning now to FIG. 2, the thrust unit 10 is shown with rod string 12. The thrust unit 10 comprises a rail 20, a thrust frame 22, a rod gripping assembly 24, two cylinders 26, two rams 28, a rod spinner 30 and a stationary frame 32. The thrust frame 22 is movable along the rails 20 relative to the stationary frame 32. The thrust frame 22 supports the rod gripping assembly 24, the two cylinders 26, two rams 28 and rod spinner 30. As shown, the thrust frame 22 comprises wheels 34 for interaction with the rail 20. One of ordinary skill will appreciate that rack-and-pinion, pulley, or other systems are appropriate for movement of the thrust frame 22 relative to the stationary frame 32. Further, the thrust unit 10 may be operable with different numbers of cylinders 26 and rams 28. Two cylinders 26 and rams 28 are chosen for convenience in the figures and are not limiting on this invention. An appropriate thrust unit for use with the present invention is disclosed in co-pending and co-owned U.S. patent application Ser. No. 14/206,548, filed Mar. 12, 2014, the contents of which are incorporated fully herein.

The rod gripping assembly 24 travels toward and away from the stationary frame 32 as the thrust frame 22 moves along the rails 20. The cylinders 26 are connected on a first end to the thrust frame 22 and on a second end to the stationary frame 32. Each cylinder 26 comprises a cylinder rod 36. The cylinder rods 36 are movable between a retracted and extended position in response to flow of hydraulic fluid to and from the cylinders 26. As shown, cylinder rods 36 of the cylinders 26 are in the extended position. The cylinders 26 expand and retract to increase or decrease the distance between the stationary frame 32 and the thrust frame 22, causing the rod string to either push into the ground or be pulled out of the ground. As shown, the cylinders 26 are diagonally disposed about the thrust frame 22 and therefore the rod string 12.

With continued reference to FIG. 2, the rams 28 provide additional pull back load when the pull back of cylinders 26 alone is insufficient. The rams 28 comprise a contact surface or thrust nose 38 for contacting the stationary frame 32. As shown, the thrust nose 38 is a rounded nose, though a flat end or other configuration may be used. The rams 28 are hydraulically actuated and mechanically retracted cylinders moveable between a retracted and extended position in response to the flow of hydraulic fluid. The rams 28 are attached at a first end to the thrust frame 22 but not attached to the stationary frame 32.

The rod spinner 30 threads on or off sections of the rod string 12 to make up or break out the rod string during pushing or pulling operations. The rod spinner 30 may alternatively connect sections of the rod string without threading, if unthreaded sections are utilized. A rod support frame 40 travels with the thrust frame 22 and maintains alignment between a rod section about to be added or a newly removed rod section.

The stationary frame 32 is a reaction plate that is positioned to ground the machine 10 and allow the extension of the cylinders 26 to cause the thrust frame 22 to pull or push the rod string. The stationary frame 32 comprises a central aperture 42 and jacks 44. The rod string 12 travels through the central aperture 42 and through the rod gripping assembly 24. Jacks 44 stabilize the stationary frame 32 to the ground such that the operation of the thrust unit 10 does not cause excessive movement in the stationary frame.

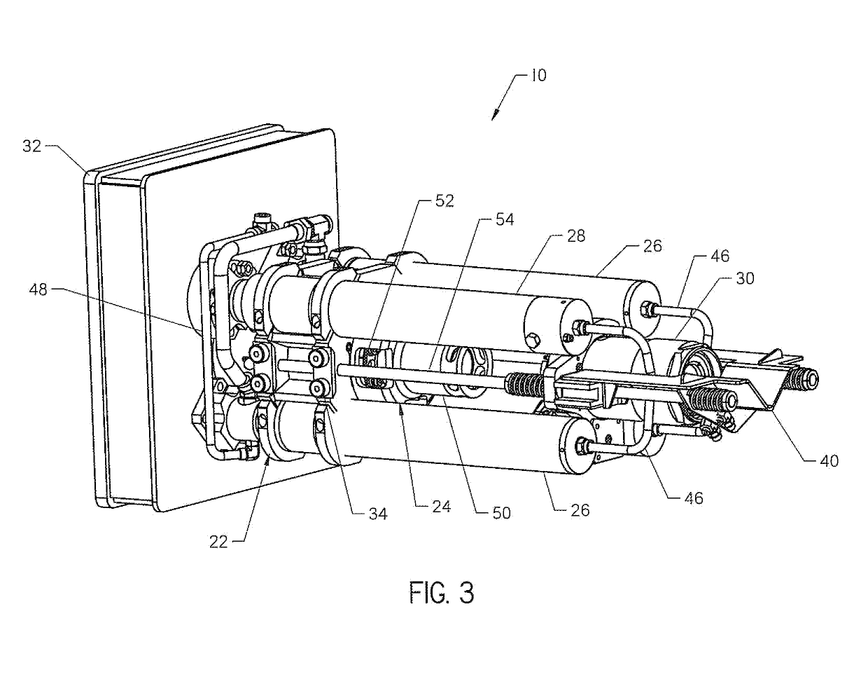

Turning now to FIG. 3, the device of FIG. 2 is shown from the opposite end. Rails 20 and jacks 44 (FIG. 2) have been removed for clarity. However, hydraulic lines 46 and 48 are shown to illustrate the hydraulic pathways used to power operation of cylinders 26 and rams 28. The cylinders 26 are shown retracted so that the thrust frame 22 is disposed immediately adjacent the stationary frame 32. The rod gripping assembly 24 is shown disposed between the cylinders 26 and rams 28. An actuator 50, thrust member 52, and rails 54 are the only visible components of the gripping assembly 24. Each of these components will be discussed hereinafter.

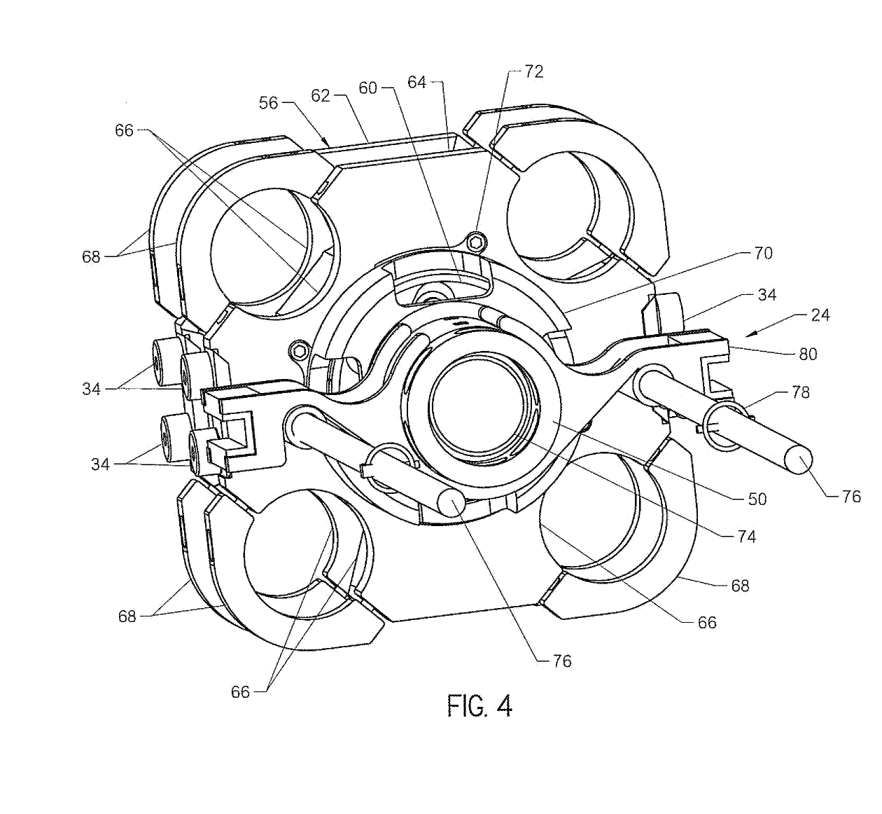

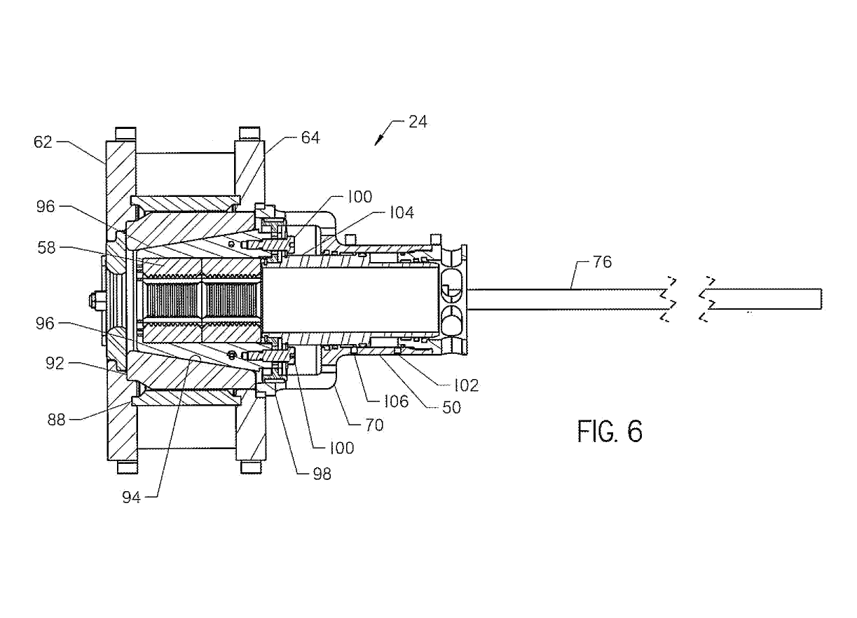

Turning now to FIG. 4, the rod gripping assembly 24 is shown in detail with other components of the machine 10 stripped away for clarity. The rod gripping assembly 24 comprises a slip bowl assembly 56, a pair of jaws 58 (FIG. 6), a thrust member 60 aligned with the slip bowl assembly, and the actuator 50. The slip bowl assembly 56 comprises a front flange 62 and a rear flange 64. The front flange 62 and the rear flange 64 may comprise a flat steel plate each having a set of four pockets 66 formed around the plates' periphery. The pockets 66 receive the cylinders 26 or rams 28 (FIG. 2) and connect the cylinder and ram housings to the thrust frame 22 for movement therewith. Bolt on caps 68 secure the cylinders 26 or rams 28 to the flanges 62 and 64. Wheels 34 are attached to the flanges 62 and 64 and as previously discussed ride along rails 20 (FIG. 2).

A bracket 70 is attached to the rear flange 64 to support the actuator 50 in alignment with the slip bowl assembly 56. The bracket 70 may be fastened to the rear flange 64 with bolts 72. The actuator 50 is supported by the bracket 70 and comprises a hydraulic cylinder having an opening 74 which allows the rod string to pass through the actuator,

The rod gripping assembly 24 has a pair of shafts 76 to support the front flange 62, a bowl 92 (FIG. 6), the rear flange 64 and the actuator 50 in series. Grenade pins 78 secure the rod support 40 (FIG. 3) to the shafts 76 for optional quick removal of the rod support. A yoke 80 is connected to the actuator 50 and is secured to the shafts 76 to fix the actuator housing on the shafts.

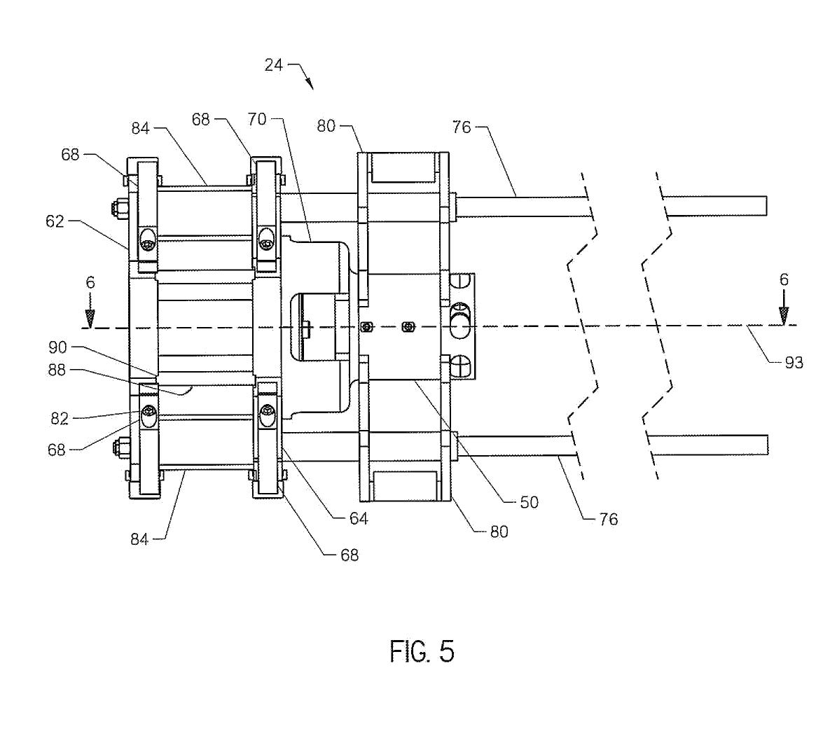

Turning now to FIG. 5, the rod gripping assembly 24 of FIG. 4 is shown from a top view. The front flange 62, rear flange 64, and yoke 80 are all shown supported on shafts 76. Although cylinders 26 and rams 28 are not shown in FIG. 5, bolt on caps 68 are shown secured to the flanges with bolts 82. Spacers 84 are disposed between the front and rear flange 62 and 64 and on the shafts 76 to provide structural support between the outer periphery of the two flanges. A bowl ring 88 is also supported between the front flange 62 and the rear flange 64. The bowl ring 88 is supported within a pocket 90 formed in the front flange 62 and secures a bowl 92 (FIG. 6) between the front flange 62 and the rear flange 64.

The bracket 70 is supported on a side of the rear flange 64 opposite the bowl ring 88. The bracket 70 supports the actuator 50 in-line with the centerline axis 93 of the rod gripping assembly 24. The yoke 80 is connected to the actuator 50 and supports the actuator on the shafts 76.

Referring now to FIG. 6, the rod gripping assembly 24 from FIG. 5 is shown in longitudinal section along line 6-6. The rod gripping assembly 24 comprises the front flange 62, rear flange 64, the bowl ring 88 supported between the front flange and the rear flange and a bowl 92. The bowl 92 is supported within the bowl ring 88 and has a conical opening 94 with a greater diameter at an end proximate the rear flange 64 and a lesser diameter at an end proximate the front flange 62. A pair of slips 96 configured to engage the opening 94 of the bowl 92 are positioned within the bowl. The outer surface of the slips 96 may be angled to cause the slips to move toward each other as they are moved into the bowl along the conical surface 94 toward the front flange 62. As previously discussed the angle of slips is between 5 and 15 degrees and preferably 10 degrees. The slips 96 may be connected to a thrust member 98 using fasteners 100. Alternatively, the slips 96 may be integrally formed with thrust member 98. The thrust member 98 is aligned with the opening 94 of the bowl 92.

The pair of slips 96 support jaws 58 disposed within the slip bowl assembly and around a rod string section 12 (FIG. 1) disposed within the bowl 92 to grip the rod string. The jaws 58 have a cylindrical inner surface matching the cylindrical surface of the rod. The jaws 58 may comprise a hardened and serrated insert used to bite into the rod surface. The jaws 58 may be a replaceable component within the slip. Of course one skilled in the art will appreciate the slips and jaw structure may be integral.

Thrust member 98 is connected to bracket 70, which is connected to actuator 50. The actuator 50 is a dual-action device that can move the thrust member 98, slips 96, and the jaws 58 relative to the slip bowl 92 to push the jaws into the slip bowl to grip the rod string section (FIG. 2) disposed within the slip bowl assembly. Actuator 50 may also pull the thrust member 98 away from the bowl 92 to partially withdraw the jaws 58 from the opening 94 to cause the jaws to release the grip on the rod string section. The actuator 50 may comprises a hydraulic cylinder, a pneumatic cylinder or an electric motor used to push and pull the thrust member 98 and jaws 58. In the hydraulic cylinder shown in FIG. 6, when pressurized fluid enters actuator 50 through port 102 the cylinder rod 104 is extended to push the thrust member 98 and jaws 58 toward the end of the bowl 92 having the lesser diameter. When pressurized fluid enters the actuator 50 through port 106 the cylinder rod 104 is retracted and the jaws 58 are partially withdrawn from the bowl 92 and the grip on the rod section is released.

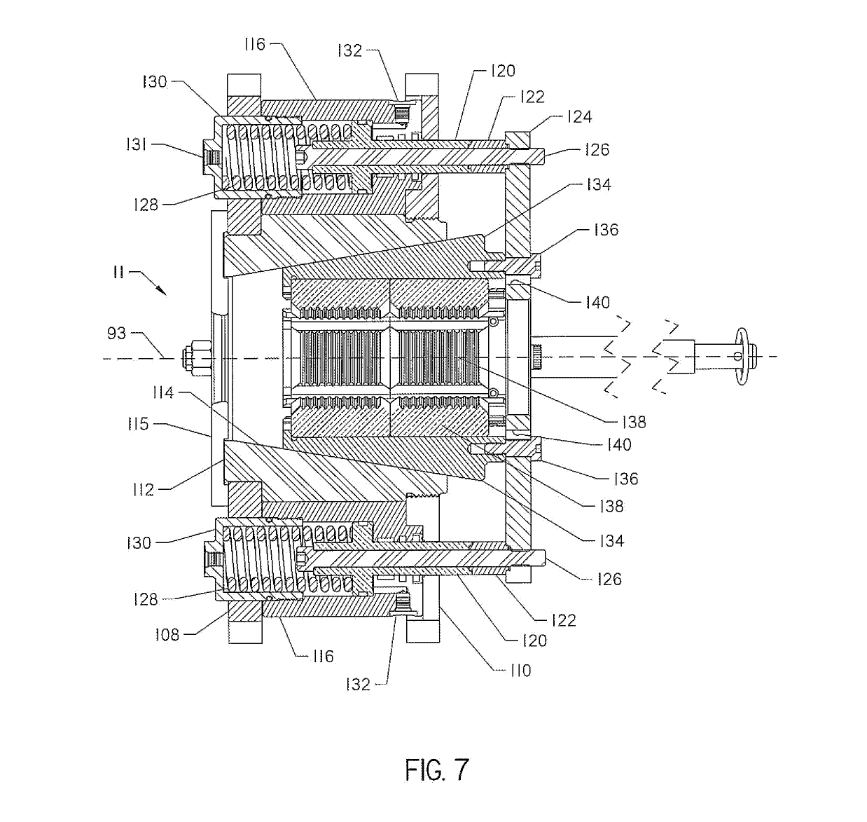

Turning now to FIG. 7, an alternative embodiment of the rod gripping assembly of the present invention is shown. The embodiment of FIG. 7 comprises a front flange 108 and a rear flange 110. The flanges 108 and 110 are plates having a plurality of holes formed therein for supporting different structures of the assembly. The flanges 108 and 110 are also connected to the cylinders 26 (FIG. 2) to facilitate movement of the entire assembly along rails 20 (FIG. 2). A bowl 112 is positioned between flanges 108 and 110 and secured with a threaded joint or concentric projection. The bowl 112 has a conical inner surface 114 having a lesser diameter proximate the front flange 108 and a greater diameter proximate the rear flange 110. A centering flange 115 guides the rod string through bowl 112 when jaws 138 are clamped. Centering flange 115 helps maintain the alignment of the rod string with the central axis 93 of the assembly.

Actuators 116 are secured between flanges 108 and 110 with a rod 120 of each actuator extending through a hole in flanges 108 and 110. A spacer 122 facilitates actuator 118 and 116 assembly into the flanges 108 and 110 and mounts to the thrust member 124 via fasteners 126. In the embodiment of FIG. 7, the thrust member 124 also comprises a yoke. Compression springs 128 are disposed within a spring cup 130 and function to extend rods 122 and therefore yoke 124 out and away from bowl 112 when no hydraulic fluid is present on the rod side of actuators 116. When pressurized fluid enters actuators 116 through ports 132, the springs 128 are compressed and yoke 124 moves closer to bowl 112. As yoke 124 moves, so to do slips 134. The spring cups 130 comprise air vent ports 131 to allow air to escape from the chamber containing the springs 128 when the rods 122 are moved to the left in FIG. 7.

Slips 134 are bolted in the tension/compression directions to the thrust member/yoke 124 by fasteners 136. Jaws 138 may be affixed to the slips 134. Jaws 138 are susceptible to wear and are therefore designed to be replaced easily, reusing slips 134. Slips 134, jaws 138 and fastener 136 make up an assembly that moves as a unit. While fastener 136 extends through yoke 124, the shouldering configuration causes the slips 134 to be loose in the obround holes 140 through which the bolts 136 extend.

The conical inner profile 114 of the bowl 112 causes a reduction in the distance between jaws 138 when slips 134 are thrust deeper into bowl 112. This reduction in distance causes jaws 138 to squeeze down and clamp on the rod string (FIG. 1).

In operation, the push/pull machine 10 is positioned at a desired location such as a launch pit and a rod string is placed within the machine and started into the bore 14. Rod string sections are added to the uphole end of the rod string 12 using the spinner 30. Once a new rod string section has been connected to the uphole end of the rod string, the actuator 50 is operated to move the pair of jaws 58 or 138 within the slip bowl assembly 92 or 112 to grip the rod section. After the rod string has been gripped, the rod string section is thrust toward the underground pipe using the cylinders 26 while maintaining the grip to push the rod string into the pipe. Gripping the rod string section may be accomplished by activating the actuators 50 or 118 and 116 to move the jaws 58 or 138 to a gripping position. At the end of the cylinders' 26 push stroke the rod string section is released by partially withdrawing the pair of jaws from the slip bowl assembly. The rod gripping assembly 2 is moved toward the proximate end of the rod string section and the rod section is gripped again. The rod string is repeatedly gripped and released with the pair of jaws in coordination with operation of the cylinders 26 to thrust the distal end of the rod string to the target location.

The rod string is pushed into the ground or underground pipe until a distal end of the rod string reaches a target point. A downhole tool and a new pipe may then be connected to the distal end of the rod string. The downhole tool and new pipe are then pulled through the ground toward the machine 10 by repeatedly gripping and releasing the rod string to pull the rod string until it is removed from the ground and the new pipe has been pulled into its desired location.

Various modifications can be made in the design and operation of the present invention without departing from the spirit thereof. Thus, while the principle preferred construction and modes of operation of the invention have been explained in what is now considered to represent its best embodiments, which have been illustrated and described, it should be understood that the invention may be practiced otherwise than as specifically illustrated and described.

What is claimed is:

1. An apparatus for pushing and pulling a rod string, the apparatus comprising:
a downhole tool;
wherein the rod string is connected to the downhole tool at a first end and comprises a plurality of rod string sections connected together end-to-end;
a stationary frame having an opening for the rod string to pass through the stationary frame;
a rod gripping assembly comprising;
a slip bowl assembly;
a pair of jaws disposed within the slip bowl assembly and around a rod string section disposed within the slip bowl assembly;
a thrust member aligned with the slip bowl, wherein the pair of jaws are connected to the thrust member; and
an actuator to move the thrust member and the pair of jaws relative to the slip bowl assembly to push the pair of jaws into the slip bowl assembly to grip the rod string section disposed within the slip bowl assembly;
a cylinder assembly operable to push and pull the rod gripping assembly relative to the stationary frame when the pair of jaws is gripping the rod string and to move the gripping assembly relative to the rod string when the actuator has moved the yoke away from the slip bowl assembly to release the grip of the pair of jaws.

2. The apparatus of claim 1 wherein the downhole tool comprises a pipe burster and a swivel for connecting the downhole tool to a new pipe to replace an underground pipe.

3. The apparatus of claim 1 wherein the stationary frame comprises a reaction plate to disperse force generated by the cylinder assembly.

4. The apparatus of claim 1 further comprising a spinner assembly to rotate a rod string section being added to or removed from the rod string.

5. The apparatus of claim 1 wherein the cylinder assembly is connected to the stationary frame.

6. The apparatus of claim 5 further comprising a rail engaged with the stationary frame, wherein the rod gripping assembly is movable toward and away from the stationary frame on the rail in response to operation of the cylinder assembly.

7. The apparatus of claim 1 wherein the slip bowl assembly comprises:
a front flange;
a rear flange;
a bowl ring supported between the front flange and the rear flange; and
a bowl supported within the bowl ring and having an opening with a greater diameter at an end proximate the rear flange and a lesser diameter at an end proximate the front flange, wherein the pair of jaws are disposed within the bowl to grip the rod string.

8. The apparatus of claim 7 further comprising a shaft to support the front flange, the bowl, the rear flange, and the actuator in series.

9. The apparatus of claim 8 further comprising a yoke to support the actuator on the shaft, wherein the thrust member is connected to the actuator, and only the thrust member, is movable along the shaft.

10. The apparatus of claim 1 wherein the thrust member is connected to the actuator.

11. The apparatus of claim 7 wherein the front flange and the rear flange both comprise a cylinder pocket to support a cylinder of the cylinder assembly.

12. The apparatus of claim 1 wherein the cylinder assembly comprises a pair of hydraulic cylinders comprising a rod and cylinder housing, wherein the rod gripping assembly is connected to an end of the rod for movement therewith.

13. The apparatus of claim 1 wherein the actuator comprises a hydraulic cylinder.

14. The apparatus of claim 1 further comprising a pair of slips to support the pair of jaws.

15. A rod gripping assembly, the assembly comprising:
a slip bowl assembly comprising:
a front flange;
a rear flange; and
a bowl supported between the front flange and the rear flange, the bowl having an opening with a greater diameter at an end proximate the rear flange and a lesser diameter at an end proximate the front flange;
a pair of jaws disposed within the opening of the bowl and to surround a rod string section disposed within the opening;
a thrust member aligned with the opening of the bowl, wherein the pair of jaws are connected to the thrust member; and
an actuator to move the thrust member and pair of jaws relative to the bowl to push the pair of jaws into the howl toward the end proximate the front flange to cause the jaws to grip the rod string section.

16. The assembly of claim 15 wherein the actuator moves the thrust member away from the bowl to partially withdraw the pair of jaws from the opening to cause the pair of jaws to release the grip on the rod string section.

17. The assembly of claim 15 further comprising a shaft to support the front flange, the bowl, the rear flange, the thrust member, and the actuator in series.

18. The assembly of claim 17 further comprising a yoke to support the actuator on the shaft and wherein the thrust member is connected to the actuator and only the thrust member is movable along the shaft.

19. The assembly of claim 15 wherein the thrust member is connected to the actuator.

20. The assembly of claim 15 further comprising a bowl ring supported within a pocket of the front flange and configured to secure the bowl between the front flange and the rear flange.

21. The assembly of claim 15 wherein the actuator comprises a hydraulic cylinder.

22. The assembly of claim 15 further comprising a pair of slips to support the pair of jaws and engage the opening of the bowl.

23. The assembly of claim 22 wherein the slips are bolted to the thrust member.

24. The assembly of claim 22 wherein the pair of slips are integral with the thrust member.

25. The assembly of claim 22 wherein the pair of jaws are integral with the pair of slips.

26. The assembly of claim 22 wherein the pair of jaws are removable from the pair of slips.

27. A method for the replacement of an underground pipe, the method comprising:
connecting a rod string section to an end of a rod string;
gripping the rod string section by moving a pair of jaws within a slip bowl assembly;
thrusting the rod string section toward the underground pipe while gripping the rod string section with the pair of jaws;
releasing the rod string section by partially withdrawing the pair of jaws from the slip bowl assembly;
moving the pair of jaws toward a proximate end of the rod string section;
gripping the rod string section or a new rod string section connected to the end of the rod string; and
thrusting the rod string further into the underground pipe.

28. The method of claim 28 further comprising:
thrusting the rod string into the underground pipe until a distal end of the rod string reaches a target point;
connecting a downhole tool and a new pipe to the distal end of the rod string; and
repeatedly gripping and releasing the rod string to pull the rod string until it is removed from the underground pipe and the new pipe has replaced the underground pipe.

29. The method of claim 28 wherein gripping the rod string section comprises activating an actuator to move the pair of jaws to a gripping position.

30. The method of claim 28 further comprising repeatedly gripping and releasing the rod string with the pair of jaws to thrust a distal end of the rod string to a target point.
